(19) United States
(12) Patent Application Publication
(10) Pub. No.: US 2011/0106376 A1
(43) Pub. Date: May 5, 2011

(54) SYSTEM AND METHOD FOR AUTOMATICALLY CONTROLLING VEHICLE TURN SIGNAL SWITCHES

(76) Inventors: Louis Tijerina, Dearborn, MI (US); Devinder S. Kochhar, Ann Arbor, MI (US)

(21) Appl. No.: 12/609,180

(22) Filed: Oct. 30, 2009

(51) Int. Cl. G06F 7/00

(52) U.S. Cl. 701/36

(57) ABSTRACT

A method and system to automatically control turn signals in a vehicle equipped with a lane detection system. The method includes the steps of detecting a vehicle travel path, determining whether the vehicle is deviating from the travel path, determining whether to automatically activate the turn signal indicative of the change of the vehicle travel path, determining whether the vehicle has established a linear travel path after the passage of a predetermined even and deactivating the turn signal after the passage of a predetermined even after the vehicle has assumed a travel path. The system includes an ECU, a lane warning system, and an automatic turn signal switch.

### TECHNICAL FIELD

Turn signals in vehicles allow other drivers to better anticipate and see an imminent or ongoing lane change by another vehicle. Turn signal lamps are required as part of Federal Motor Vehicle Safety Standard (FMVSS) 106. Many States have mandated the use of turn signal activation to indicate lane change, though enforcement is uneven. Vehicle designs have recently added large LED arrays to side mirrors that are activated when the turn signal is activated. Unfortunately, operators of vehicles often change lanes without the use of turn signals and this sometimes leads to lane change collisions. Therefore it should be of a safety benefit for turn signals to be activated whenever the vehicle crosses a lane line into another lane, whether by intent (i.e., by a lane change maneuver) or unintentionally (i.e., via an inadvertent lane drift).

In one embodiment, one non-limiting object of the present application is to disclose at least one system and method for automatically activating a turn signal or turn signal lamps whenever there is a lane change event.

In another embodiment, one non-limiting object of the present application is to utilize a vehicle's lane departure warning system to determine whether a vehicle has crossed a lane of travel and activating a turn signal or turn signal lamps indicative of the path of vehicle travel if the turn signal is not already activated.

In another embodiment, one non-limiting object of the present application is to utilize a vehicle's lane departure warning system to determine whether a vehicle has crossed a lane of travel and activating a turn signal or turn signal lamps indicative of the path of vehicle travel if the turn signal or turn signal lamps are not already activated, and de energize the vehicle turn signal or turn signal lamps after a predetermined event, such as a period of time, a distance of travel or any other event when the vehicle has completed a change of lane maneuver.

In another embodiment, one non-limiting object of the present application is directed to a method for automatically controlling a vehicle turn signals or turn signal lamps to indicate lane change events.

In another embodiment, one non-limiting object of the present application is directed to a method for controlling a turn signal system in a vehicle equipped with a lane departure warning system

These and other objects shall become apparent upon a reading of the following description of one embodiment of the method and system disclosed in the present application.

### SUMMARY

In one embodiment, the present application relates to a system to utilize a vehicle's lane departure warning system to automatically control a vehicle's turn signal switches or lamps. In one embodiment, the system includes a lane detection warning system having sensors to gather data indicative of a vehicle path of travel and transmit such data signals to a controller to determine whether to automatically activate a turn signal switch or turn signal lamps to indicate a change in the direction of travel or to indicate a lane change to other vehicle operators. The system further may automatically deactivate the turn signal switches or lamps once a predetermined event has occurred indicative that nay lane change maneuver is completed.

In another embodiment, the present application relates to a method to automatically control a vehicle turn signal system, (either or both of turn signal lights or switches) by use of a lane warning system that includes sensors to transmit data signal indicative of vehicle lane change conditions to a controller. The controller has operating instructions that enable it to perform at least the steps of detecting a vehicle travel path; determining whether the vehicle is deviating from the travel path; determining whether to automatically activate the turn signals or turn signal lamps in the vehicle to indicate the vehicle travel path deviation; automatically activating the vehicle turn signal system indicative of the change of path of vehicle travel and determining whether the vehicle has established a path of travel after a pre-determined event has occurred and de-energizing the switch or the turn signal lamps.

### BRIEF DESCRIPTION OF THE DRAWINGS

FIG. 1 is a schematic representation of a vehicle equipped with a lane departure warning system;

FIG. 2 is a schematic representation of a software flow chart showing one method according to the present application.

### DETAILED DESCRIPTION OF A PREFERRED EMBODIMENT(S)

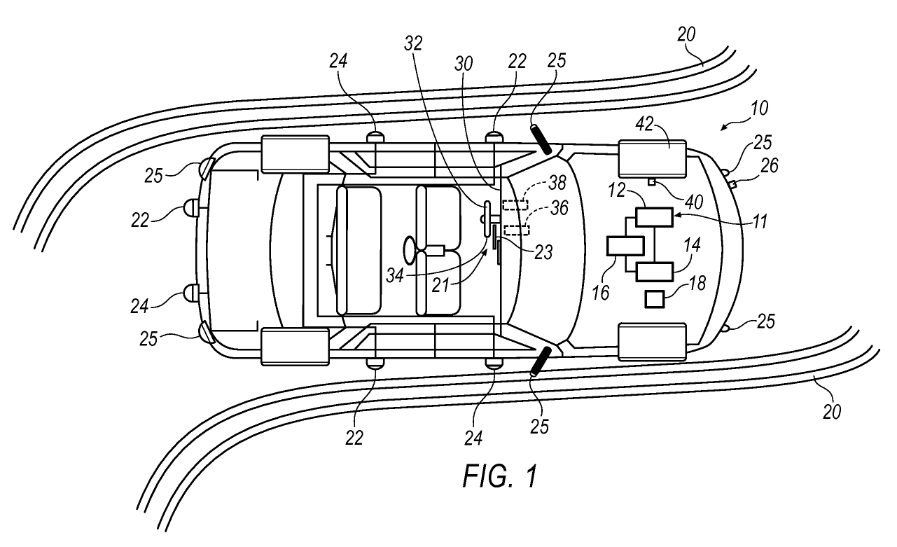

Turning now to the drawings wherein like numbers refer to like structures, and particularly to FIG. 1, a vehicle lane departure warning system is described. One such system is disclosed in co-pending application Ser. No. 12/435,922 assigned to the assignee of the present application. The system disclosed therein is incorporated by reference herein as if fully set forth. Those skilled in the art recognize that many lane departure warning systems may be utilized. Vehicle 10 is equipped with an integrated lane departure detection and warning system 11 or other integrated detection and warning system, having a lane departure detection system 12 or other environmental condition assessment system, a driver assessment system 14, and a driver warning system 16. Vehicle 10 has additional control systems, such as an engine control system 18. It will be appreciated that all vehicle control systems described herein, such as systems 12, 14, 16 and 18, have suitable hardware, memory, and software programs, not shown, to perform their control functions and may share some or all of their hardware or software components.

Vehicle 10 further has sensors providing input to lane departure detection system 12 and driver assessment system 14 to assist in implementing their respective control functions. As used herein, sensors are devices or systems of software and device providing an output usable by a control system to determine a condition of the driver, the vehicle, or the environment around the vehicle. The vehicle is further equipped with a turn signal system 21 that includes a turn signal switch 23 and turn signal lamps 25.

Sensors to detect a condition of the environment of vehicle 10 may be used to gather data and information about the area surrounding vehicle to provide input to the lane departure detection system 12 for determining where the vehicle is positioned or heading relative to lane markings 20. Environmental condition sensors may similarly be used by the lane departure detection system 12 or other driving environment assessment systems to determine if there are any other vehicles or objects in proximity to the vehicle that may pose a hazard or obstacle to the operation of the vehicle. Environmental condition sensors may include optical sensors 22 capable of detecting the position or orientation of vehicle 10 in a vehicular lane; optical, radar or other sensors 24 capable of detecting the position or motion of other vehicles or obstacles; and thermal sensors 26 capable of detecting temperature conditions conducive to the formation of ice. Other sensors, not shown, may include radio receivers capable of receiving weather and traffic information indicative of environmental conditions around vehicle 10 as well as sensors capable of detecting ice on a roadway, darkness or foggy conditions.

Sensors to detect a condition of the driver may be used to gather data to assist the driver assessment system 14 to determine the level of driver attentiveness and responsiveness or, conversely, the level of driver impairment arising, for example, from fatigue, intoxication, inattention, distraction or medical condition. Driver condition sensors may detect physical signs of driver impairment, such as slow responsiveness to prior conditions or prior warnings, or may detect biological activity, such as heartbeat, breathing rate, perspiration or movement, indicative of driver status or driver impairment. Such sensors may include dashboard mounted optical sensors 30 capable of detecting eye movement, eyelid movement, or head position, or steering wheel mounted sensors 32 capable of measuring heart rate. Still other sensors, not shown, may use the operational inputs of the driver to vehicle 10, such as the timing, frequency and aggressiveness of inputs to the steering wheel 34, the accelerator pedal 36 or the brake pedal 38 or the driver's responsiveness to prior warnings to provide data indicative of driver status.

Sensors to detect a condition of the vehicle may include vehicular operational sensors, such as wheel sensors 40 measuring the angle or rotational speed of a wheel 42. Other sensors, not shown, may include sensors measuring the speed, acceleration, jerk, or yaw of vehicle 10, or the performance of the engine or other components of vehicle 10.

While one embodiment of a lane departure warning device has been described, one skilled in the art will recognize that any lane departure warning system could be utilized according to at least one embodiment of the present application so long as the lane departure warning system so used is capable of gathering data signals indicative of whether a vehicle is traveling a travel lane and determining whether the vehicle is deviating from the vehicle lane until the occurrence of a predetermined event, at which event the turn signal system is activated and the change in lane travel is indicated by the turn signal system.

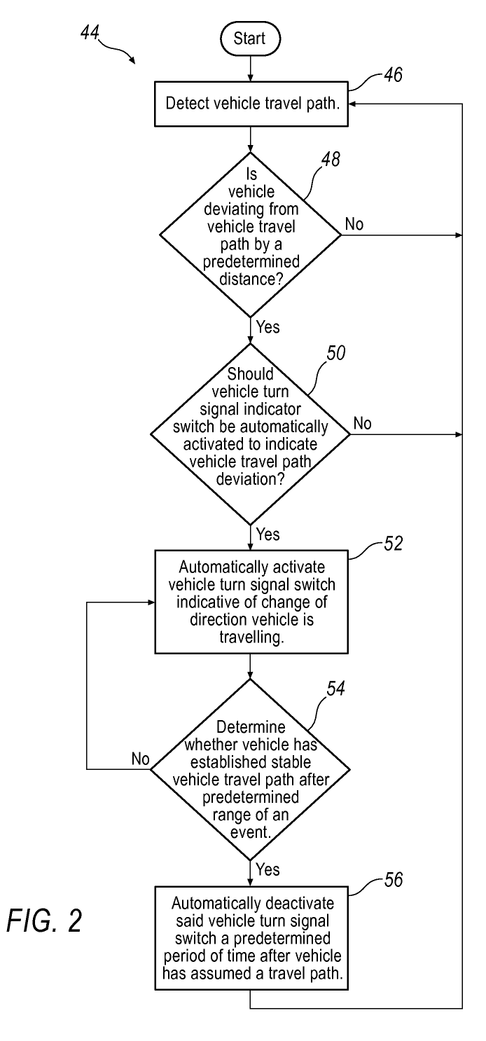

FIG. 2 is a schematic representation of method 44 according to one non limiting embodiment of the present application. Specifically, step 46 is detecting the vehicle path of travel. This is accomplished through the lane detection system or it may be accomplished through any other system such as a navigation system and the like. At step 48, a determination is made whether the vehicle is deviating from vehicle travel path by a predetermined distance. This can be accomplished by use of a lane departure warning system that can determine when a vehicle may have crossed a travel lane line, or when a vehicle lead tire has touched or crossed a travel lane line, or when the vehicle leading tire is beyond a travel lane line for a predetermined distance or for a predetermined period of time, or when the vehicle time to lane line crossing is less than a predetermined period of time. If it is determined that the vehicle has not deviated from the travel lane, the software loops back to step 46. If it is determined that the vehicle has deviated among its path of travel, step 50 is determining whether the vehicle turn signal system should be automatically activated to indicate vehicle travel path deviation, If the operator of the vehicle has manually activated the turn signal system, the software loops back to step 46. If the turn signal is not activated, step 52 is automatically activating the turn signal system, (i.e. the turn signal switch or the turn signal lamp) indicative of the direction of travel deviation. Step 54 is determining whether the vehicle has established a stable vehicle travel path for a predetermined event range. If not, the turn signal system as disclosed in step 52 remains activated. If it is determined that a predetermined event has occurred indicative that the vehicle is in a stable vehicle travel path, step 56 is automatically de-energizing the turn signal system a predetermined period of time after the vehicle has assumed a stable vehicle travel path. The software then loops back to step 46 to begin again.

The words used in this application are words of description, and not words of limitation. Those skilled in the art will recognize that many variations and modifications are possible without departing from the scope and spirit of the invention as set forth in the appended claims.

We claim:

1. A method to automatically control vehicle turn signals; said vehicle equipped with a lane detection system; said method comprising:
detecting a vehicle travel path;
determining whether said vehicle is deviating from said travel path;
determining whether to automatically activate a turn signal switch in said vehicle to indicate vehicle travel path deviation;
automatically activating said vehicle turn signal switch indicative of change of direction vehicle is traveling;
determining whether said vehicle has established a linear vehicle travel path after passage of a predetermined event; and
deactivating said vehicle turn signal after passage of a predetermined event after said vehicle has assumed a travel path.

2. The method of claim 1, wherein automatically activating said turn signal indicator occurs at least when said vehicle has crossed a travel lane line; when said vehicle leading tire is determined to be at least in said lane line; when said vehicle leading tire is beyond said lane line a predetermined distance or when said vehicle time to lane line crossing is less than a predetermined period of time.

3. The method of claim 1, wherein automatically activating said turn signal indicator occurs when said vehicle leading tire is beyond a lane line by a predetermined distance.

4. The method of claim 1, wherein automatically activating said turn signal occurs when a time to lane line crossing period is less than a predetermined time period.

5. A system to automatically activate a vehicle turn signal, comprising:
a lane warning system to sense whether a vehicle travel path is changing for a predetermined distance over a predetermined period of time;
a turn signal switch in said vehicle adapted to be automatically activatable upon receipt of a signal from said lane detection warning system indicative of a change in said vehicle path of travel beyond a predetermined distance over a predetermined period of time.

6. The system of claim 5, further including automatically deactivating said vehicle turn signal switch.
